(19) United States
(12) Patent Application Publication
(10) Pub. No.: US 2024/0325987 A1
(43) Pub. Date: Oct. 3, 2024

(54) Filtration Films Having Dense Packing of Pores of Uniform Size and Distribution, and Tools and Methods for Their Formation

(71) Applicant: MicroContinuum, Inc., Watertown, MA (US)

(72) Inventors: W. Dennis Slafer, Arlington, MA (US); David E. Wolf, Maynard, MA (US); Lawrence A. Kaufman, Wayland, MA (US); B. Diane Martin, Somerville, MA (US)

(73) Assignee: MicroContinuum, Inc., Watertown, MA (US)

(21) Appl. No.: 18/659,294

(22) Filed: May 9, 2024

Related U.S. Application Data
(62) Division of application No. 17/379,882, filed on Jul. 19, 2021.
(60) Provisional application No. 63/116,759, filed on Nov. 20, 2020.
(60) Provisional application No. 63/116,053, filed on Nov. 19, 2020.
(60) Provisional application No. 63/053,179, filed on Jul. 17, 2020.

(51) Int. Cl. B01D 69/02; B01D 63/08; B01D 67/00; B01D 69/12

(52) U.S. Cl. CPC B01D 69/02; B01D 63/082; B01D 67/0013; B01D 69/1214; B01D 69/1216; B01D 69/125; B01D 2325/0283; B01D 2325/08; B01D 2325/26; B01D 2325/30; B01D 2325/36; B01D 2325/38; B01D 2325/48

(57) ABSTRACT

Porous filters having uniform pore size and close packing density are described, along with methods and apparatus for making the porous filters based on nanopatterning. One method includes applying a polymeric liquid to a mold consisting of an array of posts having a desired pore size and distribution. Solidification of polymeric membrane followed by separation from the mold produces a polymer membrane with a predetermined spaced array of pores. A pre-filter film can also be bonded with the membrane during formation to provide increased mechanical support and filtration of larger particles on the input side of the filter. Other process variants are described, including methods for incorporating additional functionalities to the filter.

### CROSS-REFERENCE TO RELATED APPLICATIONS

This application is a divisional of and claims priority to U.S. patent application Ser. No. 17/379,882, entitled, “Filtration Films Having Dense Packing of Pores of Uniform Size and Distribution, and Tools and Methods for Their Formation,” filed Jul. 19, 2021, which application claims priority to: U.S. Provisional Patent Application No. 63/053,179, filed Jul. 17, 2020; U.S. Provisional Patent Application No. 63/116,053, filed Nov. 19, 2020; and U.S. Provisional Patent Application No. 63/116,759, filed Nov. 20, 2020; the content of each of which applications is incorporated in its entirety herein by reference.

### BACKGROUND

### Technical Field

The present relates to the field of precision liquid and gaseous filtration and discloses methods by which filters with micro- and nano-scale pores may be produced.

### Description of Related Art

Porous filters for liquids and gases are widely used in a range of applications, including industrial, chemical, geological, biochemical, biological, microbiological, molecular biological, and pharmaceutical areas, where each area has its own performance criteria. In many applications, the need is for a tight dimensional or molecular-weight cutoff. Molecular weight cut-off (MWCO) is a method of characterization used in filtration to describe pore size distribution and retention capabilities of membranes. It is typically defined as the lowest molecular weight (in Daltons) at which greater than 90% of a solute with a known molecular weight is retained (rejected or caught) by the membrane. A first example is in the pharmaceutical and related industries, where there is a need to exclude microorganisms from aqueous samples. This is typically accomplished with a 0.2 or 0.22 μm filter. A second and related example for air filtration is masks in the workplace and firefighting industries, where there a need is to exclude, for example, environmental dust or smoke. A third example is medical masks, such as the so-called N95 mask, where the need is to exclude airborne pathogens using a 0.3 μm filter. Significantly, such masks are designed to exclude 95%, as the name implies, of such airborne pathogens or aqueous droplets containing pathogens. A fourth, and more stringent example is concentrating membranes used in biochemical purification processes. Examples are the Millipore Ultra Centrifugation cellulose membrane filters, which can achieve molecular weight cutoffs as low as 3000 Da. A fifth and even more stringent example is reverse osmosis filters used in desalination.

Size-based filtration is ubiquitous in science and industry and may conveniently be divided into five categories based upon size range: ionic (pore size <0.001 μm), molecular (pore sizes around 0.01 μm), macromolecular (pore sizes around 0.1 μm), microparticulate (pore sizes around 10 μm), and macroparticulate (pore sizes >100 μm). Ionic sizes include salts, sugars, and organic dyes. Molecular sizes include proteins, complex carbohydrates, endotoxins, small viruses, and prions. Microparticular sizes includes cells, larger viruses, yeast, bacteria, smoke, and asbestos. Macroparticular sizes includes granular activated charcoal and sand.

This list is not meant to be complete or to exclude other types of membranes, as numerous methods exist for making filters that operate on different principles, including tortuous paths, electrostatic binding, track-etched holes, etc.

For the example of volume filters, the cutoff is statistical, meaning that there is a bandwidth or distribution of sizes that can pass through the membrane or filter. It is for that reason that N95 masks, for example, do not exclude 100% of particles in an air sample. In many applications it is desirable to have very tight dimensional cutoffs (filtering limits). A close to perfect cutoff can be achieved by making a filter with uniform pores or through holes with dimensions below a certain size. Such a filter can be produced with track-etched (TE) membranes, such as Nucleopore Membranes currently produced by Whatman-Cytiva. These are produced by a process referred to as track-etching. Substrates such as polycarbonate, polyester, polyimide, and others are bombarded by a high energy heavy ion beam, typically in the 4 to 15 MeV energy range. These swift heavy ions penetrate the substrate, leaving behind a cylindrical beam path (track) in the substrate in the form of a latent image. These tracks are then chemically etched, typically with an alkaline solution to produce pores with controlled sizes. The diameter of the pores is controlled by etch parameters: time, alkalinity, and temperature. Homogeneous pores as small as 10 nm may be obtained by this method.

A limitation of TE filter membranes is shown in FIG. 1, which is a scanning electron micrograph (SEM) of a commercially available track-etched polycarbonate film showing nominal pore size (approximately 200 nm dia.) and pore distribution within the film. Significant are the undesired overlapping holes that effectively create larger pores that are multiples of the target hole diameter, allowing larger particles through the membrane. To achieve uniformity of pore size and eliminate overlapping pores in the prior art TE process, a low pore density must be maintained for such prior art membranes, but at the cost of strongly increasing the pressure drop across the filter and decreasing the flow rate of the filtrate. In addition to uniform pore size, in many applications it is further desirable to minimize the pressure drop and/or increase the rate of filtrate processed by the filter.

Cylindrical pore flow characteristics such as those in the TE filter or membrane can be, to good approximation, modeled by the Hagen-Poiseuille equation, which calculates the pressure drop in (Pa) across the pore under conditions of laminar flow. That is, Δp=8μQL/πR⁴, where μ is the kinematic viscosity of the fluid in (Pa sec), Q is the fluid flow in (liters/sec), L is the length of the pore (m), and R is the radius of the pore (m). For an area of N pores, the pressure drop becomes simply 8μQL/NπR⁴. For pores of micron dimensions, however, the pressure drop required to achieve reasonable flow rates is very high, and the only way to further minimize the pressure drop for a fixed pore radius and therefore cutoff is to decrease the pore length (extent along its major axis) and increase the number of pores.

In many cases it is desired to minimize the pressure drop across the membrane. To minimize the pressure drop across the filter, as shown by the Hagen-Poiseuille equation, three factors are at play: minimize pore/membrane thickness, maximize pore diameter or equivalent dimension, and maximize the pore density. It is desirable to minimize membrane filter thickness. However, thin membranes with highly dense pore packing have the problem of being extremely fragile. As a result, they typically require a backing support in the form of a pre-filter or a post-filter, and methods for attaching such a prefilter or post-filter without clogging the pores of the thin film or the pre-filter or post-filter are critical to enable the use of such membranes in a wide range of applications. For prior art track-etching processes, the density of pores must be kept low, or holes can overlap, destroying the integrity of the filter (see FIG. 1).

What is needed, therefore, is improved filtration technology that offers higher efficiency in terms of cutoff (e.g., definable geometries, dense packing with the absence of pore overlap), pressure drop, protection in biologically hostile environments, among other factors. Ideally, it should provide a sharp cut-off, highly selective bio- and particulate filtration, and be cleanable or self-cleaning and rejuvenating, filtering virtually 100% of target viruses, bacteria and particulates with high filtrate throughput and low pressure-drop across the filter.

### SUMMARY

Aspects of the present disclosure are directed to improved filters with defined pore size and packing density, methods, and tools for making such filters, as well as methods for incorporating a pre-filter without significant filter clogging. Aspects of the present disclosure are further directed to structures and methods for incorporating additional filter functionalities, such as cleanability, chemical resistance, biocidal activity and other useful features. Further aspects are directed to methods for producing tooling for producing such filters. Additional aspects are directed to tools and methods for improving the packing density and uniformity of pores in track-etched films.

To implement these methods, embodiments of the present disclosure include a nanopatterning technique in which liquid polymers, e.g., UV-curable polymers, are applied to a casting tool also (referred to as a “mandrel tool,” “post tool,” or “mandrel”) including (e.g., vertical) posts having cross-sectional shapes and spacings corresponding to those of the pores of the desired filter. For thin membrane filters that are not self-supporting, a method is disclosed for bonding a pre-filter to the membrane without clogging the filter. In another embodiment, nanopatterning techniques are used to define pore-exposure areas on substrates in which track etching is used to form pores, thus providing higher pore densities without sacrificing pore size uniformity and without creating overlapping pores (both of which are significant problems for prior art techniques).

An aspect of the present disclosure is directed to methods of making pore-forming or casting tools having high-aspect ratio posts that can survive the casting and peel-off processes—of filter formation according to the present disclosure-without post breakage. Methods for producing pore-forming tools can include, but are not limited to, fabricating post array tools by nanoimprinting of flexible polymer films, or by metal plating, such as by Ni electroforming or by other electro- or electroless plating techniques. An array of posts can be made by etching silicon wafers or the like, although such tools tend to be brittle and prone to post breakage, in addition to being very expensive to replace when damaged. Therefore, a significant aspect of the present disclosure is the formation of durable and inexpensive pore-forming tools.

Other aspects and advantages of the present disclosure will become apparent from the following detailed description, taken together with the accompanying drawings, illustrating by way of example the principles embodied in the present disclosure.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps. Unless otherwise noted, the dimensions of the layers in these illustrations are not necessarily shown to scale.

FIG. 1 is a scanning electron micrograph (SEM) image of a prior art track-etched plastic film showing the typical distribution of pores.

FIGS. 2a-2b show SEM images in cross-sectional and tilted views of a post template made in etched silicon, in accordance with an exemplary embodiment of the present disclosure.

FIGS. 3a-3d together are a schematic of one embodiment of the membrane fabrication process for reducing pore sealing during fabrication, in accordance with the present disclosure.

FIGS. 4a-4b together are a schematic of another embodiment of the membrane fabrication process using plasma etching to open pores sealed by excess polymer material, in accordance with the present disclosure.

FIGS. 5a-5b together are a schematic of one embodiment for completing the pore formation process using electrostatic perforation, in accordance with the present disclosure.

FIGS. 6a-6f show one embodiment of a process for bonding a porous pre-filter layer to the membrane without clogging the filter, in accordance with the present disclosure.

FIGS. 7a-7b illustrate a method for adding functional layers to the filter stack, in accordance with the present disclosure.

FIGS. 8a-8c show a cross-sectional schematic of a method for forming functional relief structures on the input side of a bonded pre-filter, in accordance with the present disclosure.

FIG. 9a is a cross-sectional schematic of a pore-forming tool having tapered posts for forming tapered filter pores and for improving separation of the tool and filter membrane, in accordance with the present disclosure

FIG. 9b is a cross-section of a pore-forming tool having stepped posts, in accordance with the present disclosure.

FIG. 9c is a cross-section of a pore-forming tool in which the tips of the posts are pointed, in accordance with the present disclosure.

FIG. 10a is a face-view of a design for a wafer post array having walls separating groups of posts, in accordance with the present disclosure.

FIG. 10b is a cross-sectional view of the walled post layout of FIG. 10a that includes a bonded pre-filter to illustrate the advantages of post protection during molding, controlling the depth of penetration of the posts into the pre-filter, and improving membrane thickness uniformity, in accordance with the present disclosure.

FIG. 10c is a cross-sectional and face-view detail of a nanopore filter membrane with pre-filter backing showing stepped pores, in accordance with the present disclosure.

FIG. 11 is a schematic of a plating method for making a durable post tool for producing a nanoporous filter membrane, in accordance with the present disclosure.

FIG. 12 is a schematic of a nanoimprint method for making flexible post tool films, in accordance with the present disclosure.

FIGS. 13a-b are SEM images of a polymer post tool and polymer pores, in accordance with an exemplary embodiment of the present disclosure.

FIG. 14 is a schematic of a process for producing uniform, dense pore by track etching, in accordance with the present disclosure.

FIG. 15a is a schematic of a roll-to-roll process for continuously producing nanopore filters with a pre-filter support backing, in accordance with the present disclosure.

FIG. 15b is a schematic of a roll-to-roll process for continuously producing self-supporting nanopore filters, in accordance with the present disclosure.

FIG. 16 is a schematic of a roll-to-plate process for producing discrete nanopore filters with a pre-filter backing, in accordance with the present disclosure.

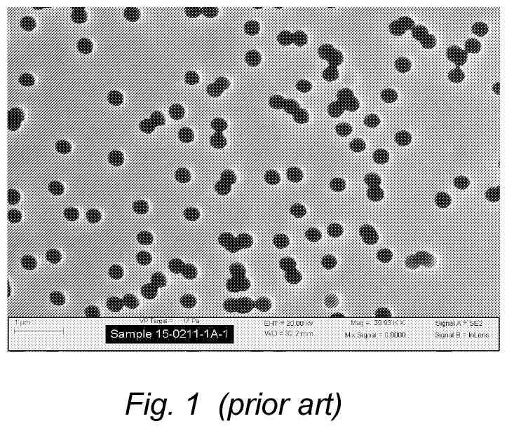

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all the components or steps that are shown or described. As used herein, the term “template” is used to refer to an original pattern, such as an etched silicon wafer having a predetermined array of posts, and the term “tool” generally refers to a structurally equivalent patterned mold made from polymeric, metal, or other suitable material. “Mandrel” is a general term for a mold capable of forming post or pore arrays and will most often be used to mean a tool having an array of posts used to make porous filters. The term “porous membrane” or “membrane” or “nanoporous membrane” will be used to mean a perforated polymeric film formed by the methods of the present disclosure having pores of pre-determined size and spacing, where such pores can have predetermined shapes that are, generally, in the multi-micron to multi-nanometer to sub-nanometer size range. The shape of the pores can be generally cylindrical, and while they can include circular cylinders, they can include other shapes extending along an axis and need not be limited to having circular apertures and/or cross-sections. Such membranes may be self-supporting or be used in conjunction with a support layer to provide suitable film strength. “Nanoporous filter” (“NP filter”) or “membrane filter” refers to a porous membrane bonded to a pre-filter layer. “Pre-filter” refers to a coarse filter material for bonding to a nanoporous membrane that provides physical support and removal of larger particles. “Resist” refers to a polymeric liquid which is ultimately solidified through exposure to UV radiation, by solvent evaporation or by chemical reaction. The terms “posts” and “pores” should not be construed to refer only to circular openings, but may also include pores having other useful shapes, e.g., square, rectangular, elliptical, etc. The recitation of numerical ranges by endpoints includes all numbers subsumed within a specified range (e.g., the range 1 to 5 includes 1, 1.5, 2, 2.75, 3, 3.80, 4, 4.5, 4.85, and 5) and any range within that range.

### Formation of Filter Membrane(s):

While circularly cylindrical pores are described herein, it is an aspect of the present disclosure that pores do not have to be circularly cylindrical, as some applications may find pores with a different opening shape and cross-sectional shape beneficial. While in general the goal is minimal pressure drop and therefore smoothest surface, the present disclosure includes pores that offer frictional resistance to flow because of the physical or chemical structure of their surfaces. For example, some application may benefit from rendering the inner surface mechanically resistive, hydrophobic, or hydrophilic, or by the addition of a binding agent for one or more solutes.

Hydrophobicity/hydrophilicity may be controlled either by choice of the membrane material or by modification of the membrane surface and/or pore interior. As an example, surfaces may be soaked in poly-lysine to make them positively charged and therefore more hydrophilic, or conversely with silanes such as Siliclad (made commercially available by Gelest, Morristown, PA) or the like, to make them more hydrophobic. Porous membranes according to the present disclosure will filter under conditions of laminar as well as turbulent flow.

The present disclosure is directed to the filtration of fluids, including both aqueous and nonaqueous liquids, other gases, and even ionic plasmas. One of ordinary skill in the art will recognize that the difference between these materials is largely one of kinetic viscosity, temperature, and surface interactions. A major distinction between liquid and gaseous filtration on the micro- and nanoscale has to do with surface tension effects. These surface tension effects relate to interactions of liquids and pores, and (in the case of gases for medical mask filters for pathogens) the formation of droplets in the gas encasing the pathogen (e.g., COVID-19 virus). In such a condition, the size to be excluded becomes that of the droplet rather than that of the pathogen.

Broadly speaking, exemplary porous filters according to the present disclosure may have through holes (pores) with a diameter or maximum opening between, e.g., 0.05 nm to 10,000 nm, depending upon the application. In some embodiments the holes can be between 5 nm and 20 nm, between 20 nm and 50 nm, between 50 nm and 300 nm, between 300 nm and 500 nm, between 500 nm and 1 μm, between 1 and 10 μm. To produce these pores, the tool posts should have corresponding sizes of between 5 nm and 20 nm, between 20 nm and 50 nm, between 50 nm and 300 nm, between 300 nm and 500 nm, between 500 nm and 1 μm, between 1 and 10 μm. Of course, the noted dimensions are given as examples, and the through holes and posts may have different dimensions within the scope of the present disclosures.

In exemplary embodiments, the spacing of the holes or pores in the membrane are preferably between 1 and 100 times the through hole diameter or maximum opening. While a hole spacing of 1 times the diameter may be implied for cylindrical pores in a hexagonal close packed configuration, the material of the membrane would likely not support such a structure. This is because the edge-to-edge spacing between the pores would essentially be zero, i.e., they would be touching. Consequently, a minimum interpore spacing is preferably used, e.g., 5%, 10%, 20%, or 30% of the pore diameter or maximum opening. So, strictly speaking, this percentage would be added to the pore maximum opening or diameter to arrive at the center-to-center spacing. For larger separation distances, the minimum interpore spacing may be ignored. The minimum interpore spacing can be selected, depending upon the precise mechanical properties of the membrane material, prefilter support, and filtration application. For example, the interpore spacing may be between 1 and 2 pore diameters, 2 and 5 pore diameters, 5 and 10 pore diameters, 10 and 50 pore diameters, 50 and 100 pore diameters. In parallel, the tool for the production of the membrane may have corresponding minimum pillar spacings (e.g., 5%, 10%, 20%, or 30% of the pore diameter or maximum opening or post maximum width) depending upon the precise mechanical properties of the membrane material, prefilter support, and filtration application. For example, pillar spacing may be between 1 and 2 pore diameters, 2 and 5 pore diameters, 5 and 10 pore diameters, 10 and 50 pore diameters, 50 and 100 pore diameters.

Within these constraints the spatial distribution of pores may be uniform according to a lattice chosen from: hexagonal, square, rectangular, oblique, and centered rectangular. Alternatively, the distribution may be semi-random or random. Here semi-random refers to either the case where an identical random distribution is periodically repeated, i.e., where a random coupon is repeated multiple times to make the tool, or where a uniform pattern is repeated either regularly or randomly but the overall pattern has spacing between the repeats. Similarly, the tool is produced with pillars whose spatial distribution of pores may be uniform according to a lattice chosen from: hexagonal, square, rectangular, oblique, and centered rectangular. Alternatively, the distribution may be semi-random or random. Here semi-random refers to either the case where an identical random distribution is periodically repeated, i.e., where a random pattern is repeated multiple times to make the tool, or where a uniform pattern is repeated either regularly or randomly but the overall pattern has spacing between the repeats.

The pores may have lengths that can be defined as an aspect ratio (pore length/pore diameter or maximum dimension). In applications where it is important to minimize pressure drop, this aspect ratio should be as small as possible. However, mechanical requirements of the filters often require larger aspect ratios. The aspect ratios required are in many cases significantly higher than nanostructures common to the art. Method embodiments of this patent relate to methods of producing both tools and membranes with these larger aspect ratios as well as supporting prefilters that enable use of the thinnest membranes possible. Embodiments of the present disclosure can have pore aspect ratios, e.g., between 0.2 and 1.0, 1.0 and 2.0, 2.0 and 5.0, 5.0 and 10.0, 10.0 and 20.0, 20.0 and 50.0. Similarly, tools according to the present disclosure can have pillar aspect ratios, e.g., between 0.2 and 1.0, 1.0 and 2.0, 2.0 and 5.0, 5.0 and 10.0, 10.0 and 20.0, 20.0 and 50.0. For membranes formed by the post tool method, a practical minimum thickness of the membrane may be greater than approximately 250 nm, and preferably is in the range from 1-10 microns.

In exemplary embodiments of the present disclosure, a free-standing nanoporous membrane is formed using a mandrel tool (mold) consisting of an array of posts over which a liquid polymer material is coated. Lamination of a temporary cover film and solidification of the polymer layer, followed by removal of the cover film and separation from the mandrel tool (or simply “mandrel”), produces a membrane with pores of a desired shape and distribution.

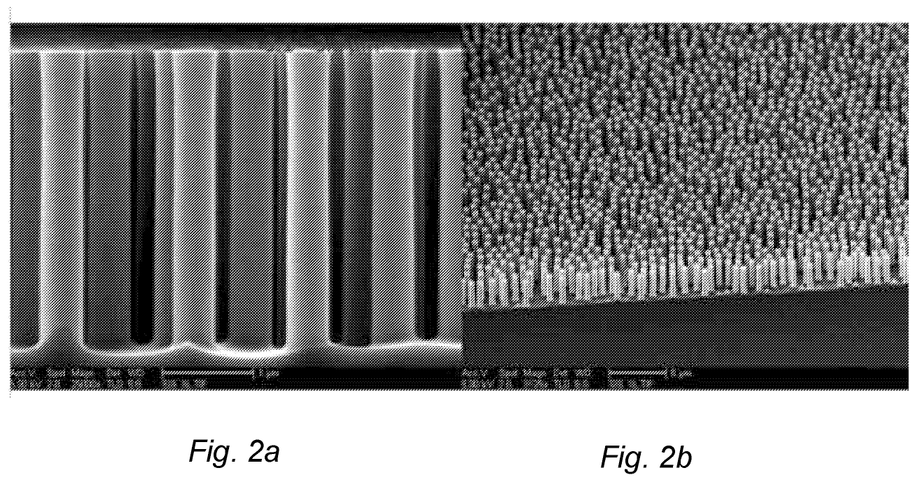

FIGS. 2a and 2b are scanning electron microscope images (SEMs) at different magnifications of a semi-random array of posts that can be used as a post tool or mandrel to form a filter membrane with corresponding pores, in accordance with exemplary embodiments of the present disclosure. Depending on mandrel design, pores can be made in desired layouts, including periodic, quasi-periodic or random, and pore shapes can include circular, square, triangular or other useful geometry.

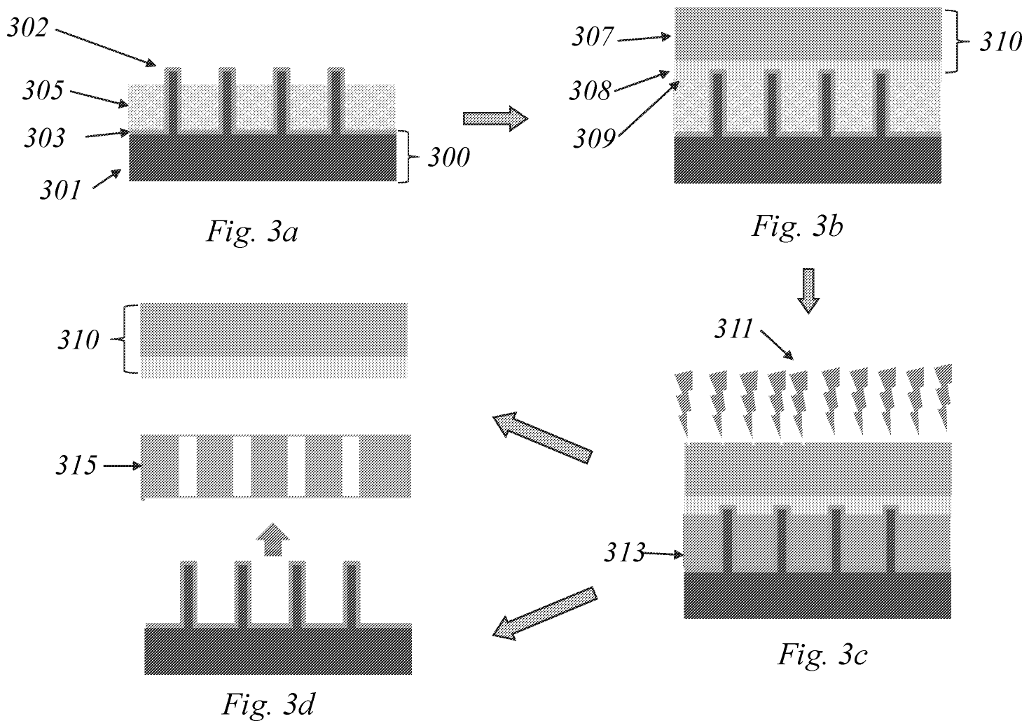

An exemplary method of porous membrane formation according to the present disclosure is shown schematically in FIGS. 3a-3d. In FIG. 3a, tool (mandrel) 300 is composed of substrate 301 and pillar array 302, where in this example the mandrel is optionally coated with release layer 303 to assist in membrane separation from the mandrel. A layer of polymer 305 (e.g., UV-curable resist 305) is applied to the mandrel, where the thickness of polymer layer 305 is less than the height of posts 302. The resist may advantageously be diluted through the use of one or more solvents to reduce its viscosity and/or surface tension so that the layer has the desired height relative to the posts after solvent removal. Suitable polymer materials for layer 305 can include, but are not limited to: (1) general polymers such as acrylate or urethane monomers, photoinitiators, adhesion promoters, hardeners, etc.; (2) Urethane Methacrylate; (3) “acrylate functionalized aromatic monomer” commercially available from MSDS; and (4) isobornyl acrylate, 2 hydroxymethyl methacrylate, acrylic acid, commercially available from MSDS; other suitable materials may be used in addition to or substitution for these.

The release layer 303 can be a thin coating of PTFE (e.g., Teflon®, or other) or a solvent-borne release agent (3M Novec®, for example) or other suitable material. In FIG. 3b, film 310 composed of substrate 307 with optional soft elastomeric layer 308, is pressed against the resist-coated mandrel such that the tops of the posts are in contact with layer 308 and polymeric layer 309, forming an air-excluding interface 309 that enables crosslinking of the resist without oxygen inhibition, while also assuring that the liquid resist level is at or below the top of the tool. In FIG. 3c, optical radiation 311 is transmitted through optically transparent substrate 310 (alternatively, through substrate 300 if transparent to the appropriate optical radiation) and solidifies the resist by polymer crosslinking to form membrane 313. Top sheet 310 and membrane 313 are separated from the mandrel 300 in FIG. 3d, producing NP membrane 315 having sufficient mechanical strength to be self-supporting. A large number of commercial UV-curable polymers are suitable for this application, such as made those by Norland (Cranbury, NJ), Dymax Corporation (Torrington CT), micro resist technology GMBH (Berlin, Germany), Loctite Brand (Rocky Hill, CT) and others.

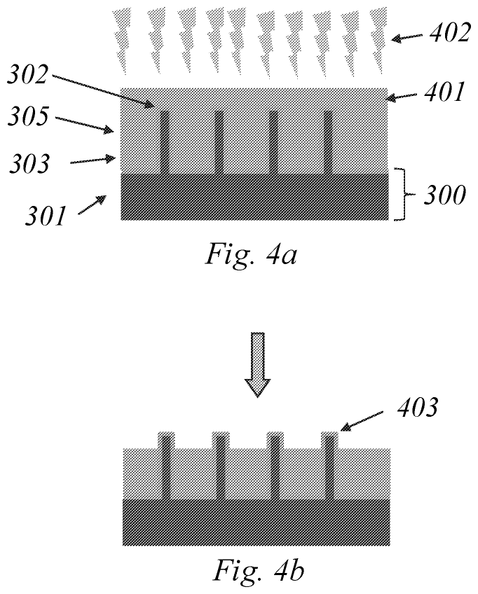

FIGS. 4a-4b together are a schematic of another embodiment of the membrane fabrication process using plasma etching to open pores sealed by excess polymer material, in accordance with the present disclosure. A cured NP membrane that extends above the tops of the posts will have pores with blind holes (i.e., having closed bottoms) rather than through holes (open pores). FIGS. 4a-4b diagram the use of plasma or other polymer etching method to remove this excess material. In FIG. 4a, mandrel 300 with pillar array 302 and optional release layer 303 is coated with resist layer 401 which extends above the tops of the pillars. Using the known techniques of plasma etching, polymer material is removed under exposure to an oxygen or other appropriate gaseous plasma 402, which converts the solid polymer to a gas that is pumped away by the vacuum system (not shown). The process is continued until posts 403 are exposed, shown in FIG. 4b. In order to reduce etching of the mandrel by the plasma, the mandrel can be coated with, or made of a material (not shown) having a much lower etch rate compared to that of the resist.

In another embodiment (not illustrated), a polymeric film on a temporary carrier is softened by heat or chemical (e.g., solvent) treatment and pressed onto the mandrel until the softened film is perforated by the mandrel. Solidification by cooling or solvent removal, followed removal of the temporary carrier and delamination of the polymer membrane from the mandrel produces a perforated membrane. As in the example shown in FIGS. 4a-4b, plasma etching can be used to open any un-perforated pores before or after separation from the mandrel.

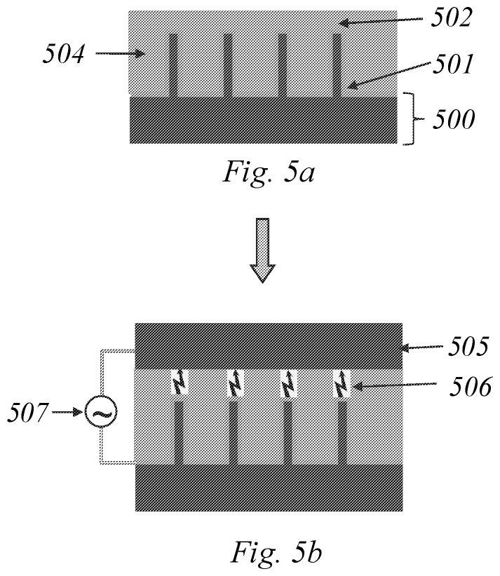

FIGS. 5a-5b illustrate another embodiment of the present disclosure; FIG. 5a shows mandrel 500, which is similar to mandrel 300 described above but here made electrically conductive by coating of conductive layer 501 over the mandrel. Alternatively, the post mandrel (post forming tool) 500 can be made from an electrically conductive material. Tool 500 is used to form blind holes 502 (i.e., not fully perforated pores) in crosslinked polymer membrane 504. In FIG. 5b, conductive substrate 505 is temporarily attached to the outer surface of layer 504 for use as an electrical ground, and high voltage discharge 5o6 is applied between conductive mandrel 501 and ground 505 by electrical generator 507 to complete the perforation of the membrane, thereby converting the previously closed blind holes into through-holes. Controlled voltage, pulse shape, pulse frequency, mandrel post design (e.g., pointed tips) etc., are used to optimize membrane perforation.

### Incorporation of Pre-Filter:

The physical strength of the porous membrane depends on the thickness and other properties of the cured polymer. Because very thin membranes are generally very fragile, it is method according to the present disclosure can include incorporation of one or more additional layers with the porous membrane, such as a bonded coarse pre-filter, which is used to both physically support a thin, porous membrane and to trap large particles that would otherwise clog or damage the membrane. Pre-filter materials can include, but are not limited to, cellulose nitrate, cellulose acetate, polypropylene, potyethersulfone, nylon, PTFE, and polyvinylidene fluoride (PVDF); other suitable materials may be used in addition to or substitution for these, e.g., metal foil or sintered metal filter material. A wide range of pre-filters and prefilter materials are commercially available (Sartorius Corporation, Bohemia NY; Whatman PLC, Kent United Kingdom; Sterlitech Corporation, Kent WA; MilliporeSigma, Burlington MA and others). Exemplary embodiments of the present disclosure can employ pre-filters having porosity of within a range of 500 nm to 50 microns, with preferred sized being within a range of 1-10 microns.

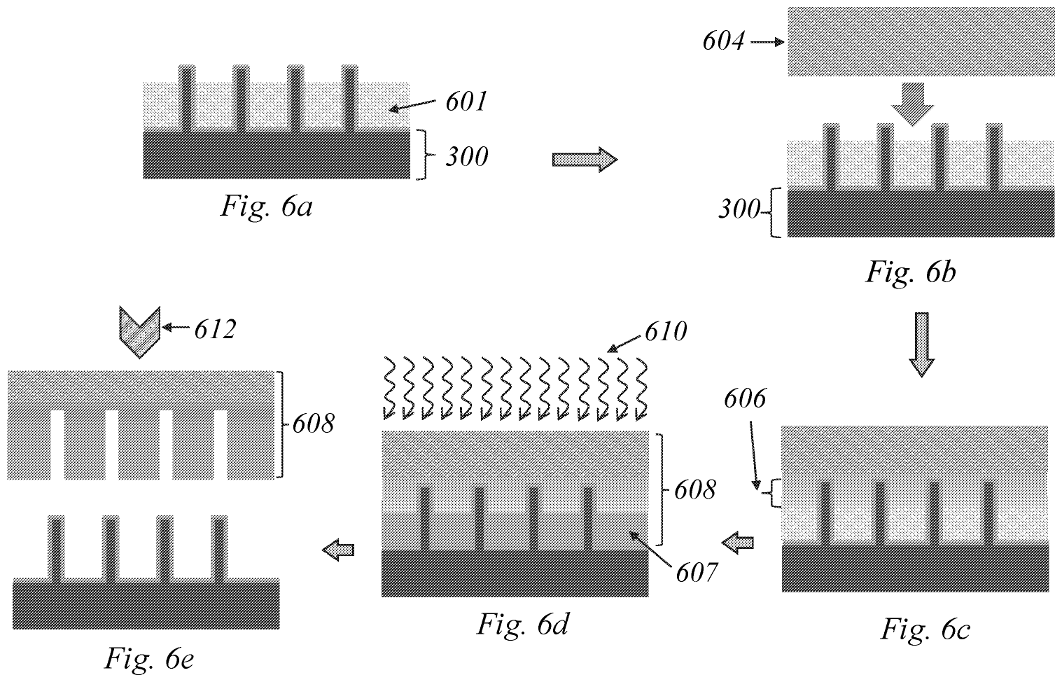

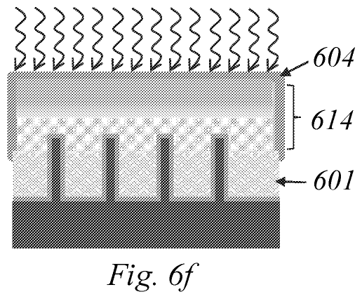

Pre-filters are commonly used with fine filters. Pre-filters are generally thick, volume filters often including a spun polymer mat or porous material with tortuous pathways extending throughout the filter. In combining the pre-filter with the porous membrane filter, it is important to avoid clogging either element of the filter. Therefore, exemplary embodiments of the present disclosure include methods for bonding pre-filters to porous membranes without clogging either, as shown schematically in FIGS. 6a-6f.

In FIG. 6a, liquid polymer resist 6o1 is shown applied onto tool 300 such that the posts extend beyond the top surface of the polymer. Pre-filter 604 is pressed onto mandrel 300, as shown in FIG. 6b, such that the posts pierce the pre-filter to assure access for the membrane pores into the pre-filter and prevent membrane polymer from clogging the pre-filter. In FIG. 6c, the pre-filter and membrane are shown in contact at 606, then fused together at in FIG. 6d by various methods depicted by 610, including heat, optical radiation, thin adhesive layer, or other bonding means. Membrane stack 608, consisting of porous membrane and bonded pre-filter, is then separated from mandrel 300, as shown in FIG. 6e. The filtration flow direction is given by arrow 612.

In a preferred embodiment, a solvent or mixture of solvents is used to dilute the membrane-forming resist prior to coating onto the mandrel. As in previous FIG. 6c, the pre-filter is pressed onto the liquid-coated mandrel so that the mandrel posts enter pre-filter 604, where the solvent-containing resist is allowed to slightly penetrate the pre-filter at interface 6o6. The solvent is removed through the pre-filter, accelerated by the use of heat, vacuum extraction, the selection of low-boiling solvent(s), or other solvent removal means. The membrane resist is then crosslinked by radiation 610, thereby forming an interlocking bond between the membrane and pre-filter. Control of the diffusion of the polymer into the pre-filter can be controlled by the concentration of solvent in the resist before pre-filter lamination, as well as by partially pre-curing the resist before lamination of the pre-filter.

FIG. 6f shows a method of the present disclosure to prevent pre-filter clogging by resist polymer during bonding. As is shown in FIG. 6f, liquid 614 is used to temporarily fill pre-filter 604 in order to block ingress of membrane resist 601 into pre-filter 604 during lamination and curing. After curing, the filter stack is removed from the mandrel and a suitable removal technique (e.g., heating or vacuum drying) is used to remove the temporary fill liquid. Fill liquid 614 is selected to have minimal or controlled miscibility with the uncured polymer resist and be easily removed from the pre-filter, without leaving any residue to contaminate the filter. Water (or other aqueous solution) is an ideal fill material 614, while other liquids or mixtures compatible with the selected pre-filter material may also be used (including, for example, alcohols, aqueous diluted alcohols, ketones, non-polar solvents, or others). The pre-fill liquid also serves to exclude oxygen that could otherwise inhibit crosslinking for UV-cure polymers. Use of a pre-fill liquid that is weakly miscible with the resist allows a small amount of resist to perfuse into the pre-filter and bind with the pre-filter structure before curing for improved adhesion and minimization of clogging. While pre-filters are described above, filter stacks according to the present disclosure can include post-filters (with or without a pre-filter); the post filters can include similar, identical, or different structures as pre-filters described herein.

### Functional Features:

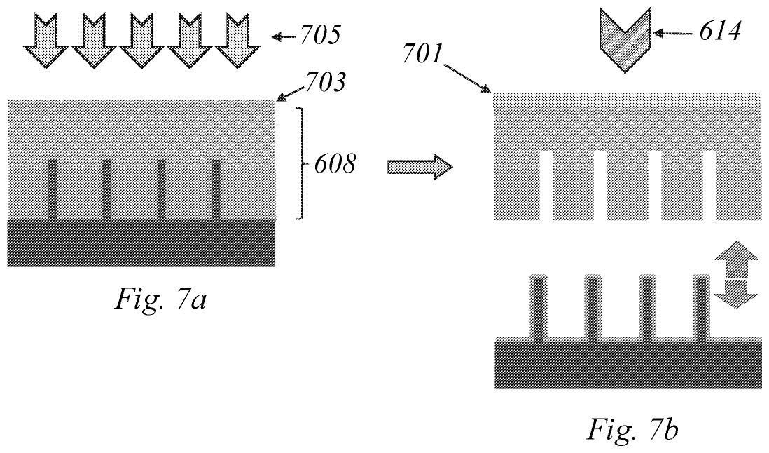

Methods and/or structures according to the present disclosure can be used to impart additional advantageous properties to the filter(s), such as hydrophobic and/or biocidal or antimicrobial characteristics. These may be added to either or both sides of the filter stack. For example, further improvements in the efficacy of filters according to the present disclosure can include incorporation of surface materials, structures, or agents for controlling surface interactions of liquids and droplets and chemistry for inactivating viruses and bacteria. Depending upon the material to be excluded these can simply be surface charge (surface charged material), capture agents, such as specific chemical groups, or lectins, or antibodies, or degradation or lytic agents such as proteases. Such agents can be incorporated either into the pore itself or on the interpore surface. Examples of the latter are “shark-skin” or “lotus leaf” structures for modifying hydrophobicity. In addition, filter materials that are resistant to chemical cleaning may be desirable for some applications. FIGS. 7a-7b illustrate a method for adding functional layers to the filter stack, in accordance with the present disclosure.

In the embodiment shown in FIGS. 7a-7b, a thin material layer 701 is applied to the input surface 703 of filter stack 608 by vacuum coating (e.g., sputtering, etc.), liquid coating or other known techniques, 705, where the thickness is suitably thin to avoid clogging the pre-filter. See FIG. 7a. This layer may be designed to provide hydrophobic, hydrophilic, biocidal, or other desirable characteristics to the filter. Hydrophobicity, for example, may be imparted through the use of PTFE, other Teflon-like material coating, 3M Novec release layer, or other thin-film materials. As another example, a NiCr or other resistive film layer may be used to enable heating of the membrane to either denature or remove biological or volatile agents from the membrane. For such applications, temperatures of >500 C are typically required to, for example, denature and deactivate pathogen nucleic acids. Moreover, metals such as Cu or Ag, for example, can impart biocidal activity to the surface on which they are applied, e.g., by vacuum deposition or by particulate adhesion.

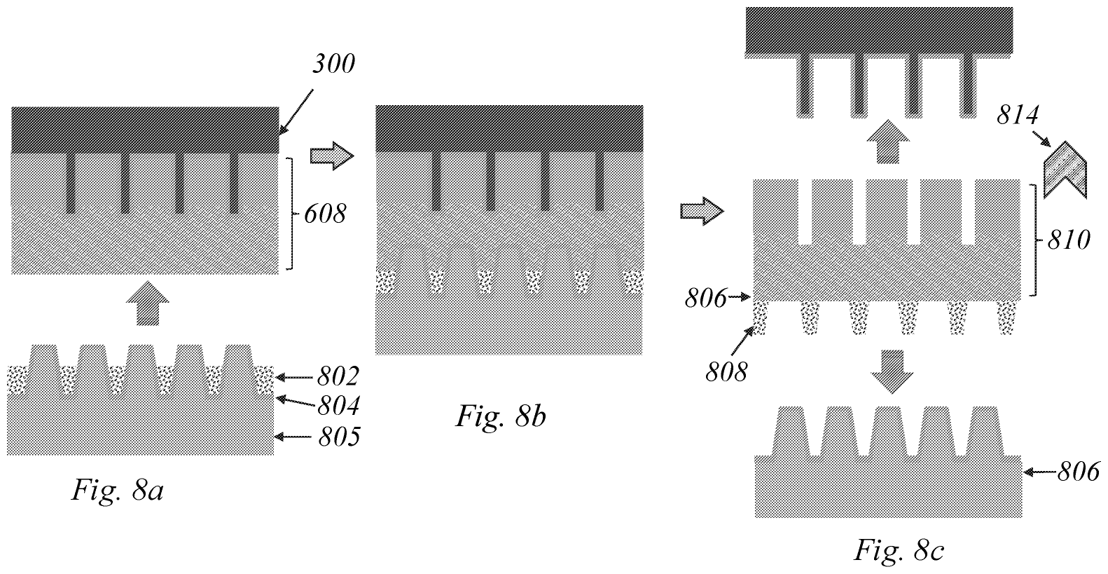

Other useful characteristics can be provided to a filter stack according to the present disclosure by incorporating patterned relief structures to the input surface of the pre-filter. For example, hydrophobicity can be provided by forming certain “superhydrophobic” surface structures known to the art, such as the “lotus leaf”-type structure. An example of such a method is illustrated in FIGS. 8a-8b.

In FIG. 8a a variant of previously described embodiments is used to imprint onto the input side of pre-filter 608 the pattern of mandrel 805. The mandrel 805 has a mirror-image of a desired hydrophobic structure and may also include optional release layer 804. Resist 802, after curing by UV, heat, or chemical reaction, forms the desired relief structure on the pre-filter, as shown in FIG. 8b. In FIG. 8c, filter 810 is peeled from the mandrel, where the input surface now has desired superhydrophobic surface 808. Material 802 is a polymer-based resist incorporating useful additives, for example nanoparticles of Ag, Cu, or other materials with known biocidal activity, or electrically conductive nanowires or nanotubes to enable static discharge or heating. The flow direction for this filter is given by 814.

### Post Shape(s):

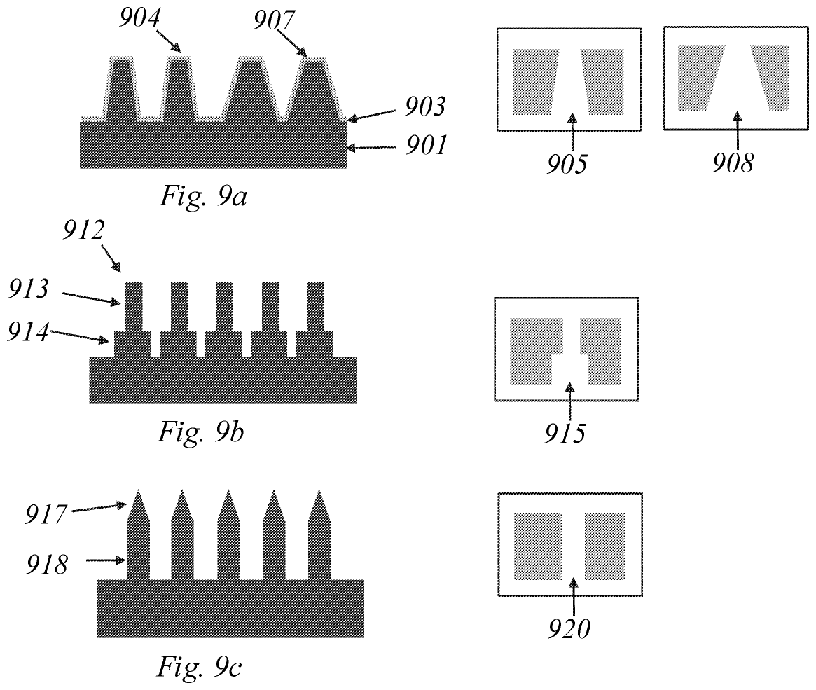

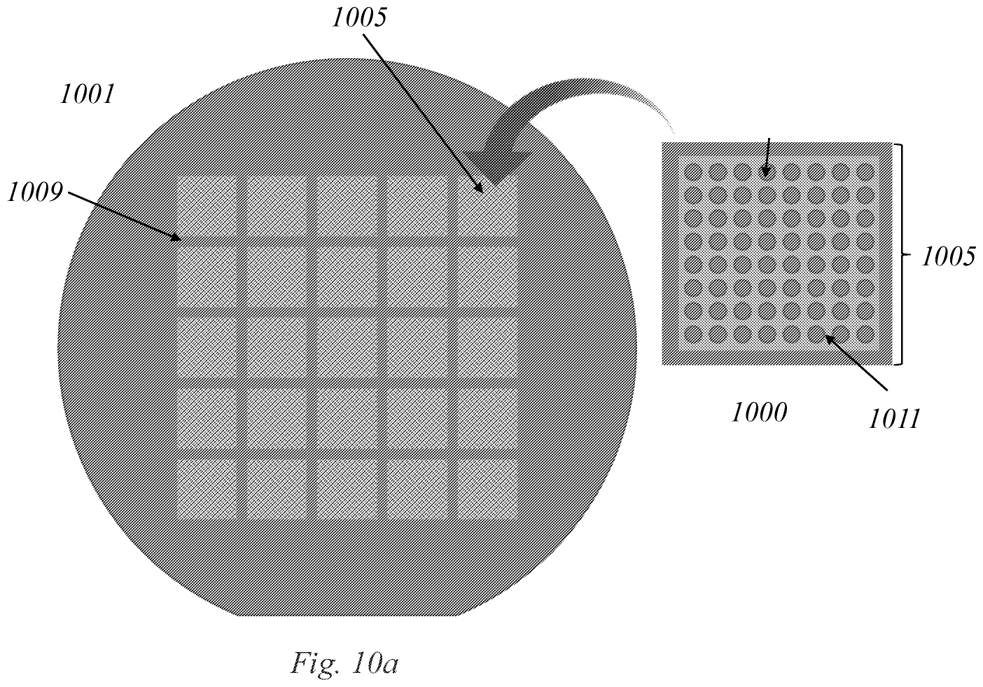

The design of the vertical profile of the tool posts can be used to improve the ease of membrane separation and the durability of the post tool. Post profile also affects the properties and performance of the filter membrane made from it. In one tool embodiment, shown in FIG. 9a, exemplary post 904 of substrate 901 is slightly tapered to reduce the force required to separate the membrane from the tool. This produces a tapered pore 905 that is beneficial for increasing the filtration flow rate through decreasing the pressure drop in the flow direction as the pore diameter increases. As another post shape example, post 907 has a greater taper angle, producing pore 908 that provides a membrane with a further decreased pressure drop.

In another tool embodiment, shown in FIG. 9b, post 912 (release layer 903 not shown) is stepped with one or more different diameters, such as 914 and 913, that decrease in diameter from the base to the top of the post. This has the advantage of strengthening the post and also defining a constant pore diameter 915 over an extended length. Lithography used to form discrete steps in some template materials, such as silicon, may be easier than creating a controlled taper.

In yet another embodiment, shown in FIG. 9c, tip 917 of post 918 has a pointed profile to improve ease of penetration into the pre-filter, in this case producing pore 920 having a uniform diameter.

The above post geometries are non-limiting examples of posts profiles, where combinations of these and other shapes can be employed. Post cross-sections are not limited to circular but may also include square, rectangular, triangular, or other cross-sectional geometries that may be beneficial.

### Post Layout:

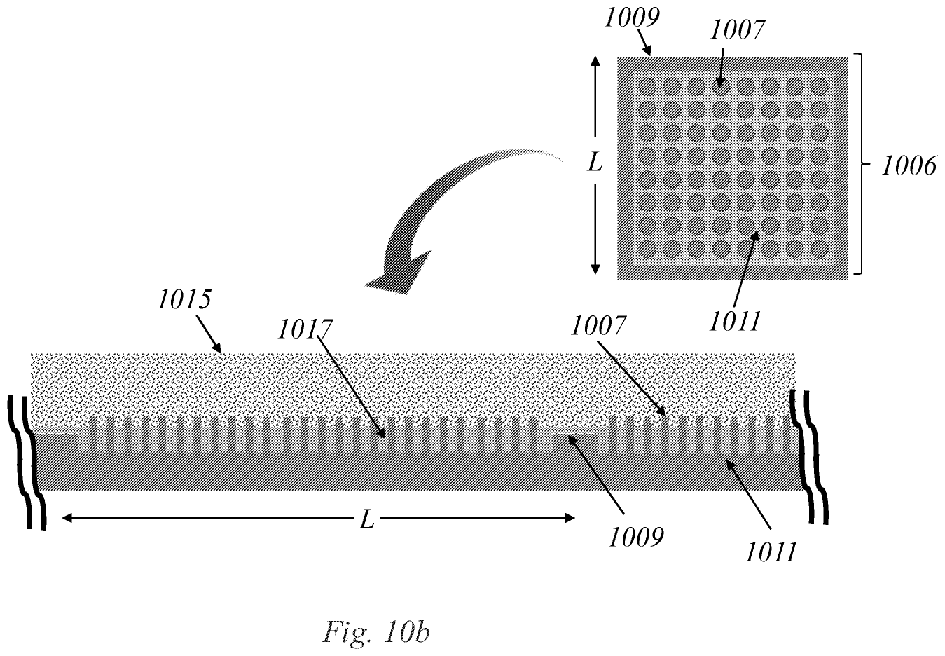

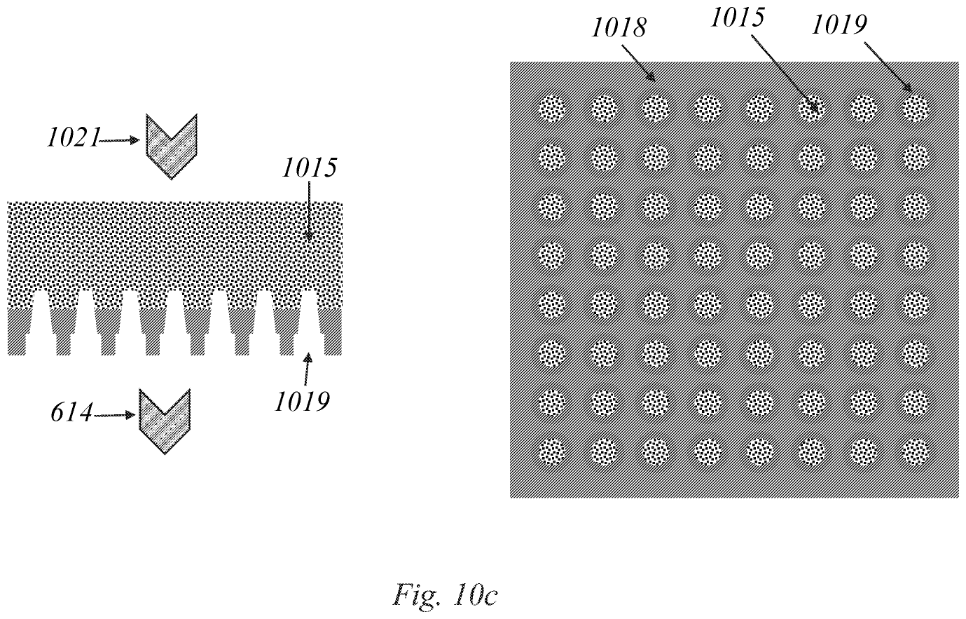

An aspect of the present disclosure provides a layout of the post mandrel tool that reduces post breakage and wear while improving nanopore replication quality. FIG. 10a is a schematic face-view of a post layout in which posts 1007 in enlargement 1000 are arranged in exemplary grouping 1005. Wafer 1001 consists of multiple copies of unit pattern 1005 with walls 1009 separating each group of post elements.

In one embodiment of this layout, shown in FIG. 10b, grouping 1006 having dimension L consists of posts 1007 extending from level 1011 below level 1009, and extending above surface level 1009. In this embodiment, the height of the posts extends above that of the surrounding walls in order to control penetration of the posts into pre-filter 1015, while also offering protection of the posts from breakoff during processing. The walls between the post groupings further act as supports for the pre-filter to produce membrane 1017 with improved thickness uniformity. FIG. 10c shows a cross-section and a corresponding face view of a NP filter made using a stepped mandrel, where 1018 is the output side of the membrane after tool separation, 1015 is a pre-filter backing layer, and 1019 is the stepped pore. The stepped pore diameter is larger at the front (output) surface to decrease the pressure drop across the filter. Flow direction is given by 1021.

### Replication Tools:

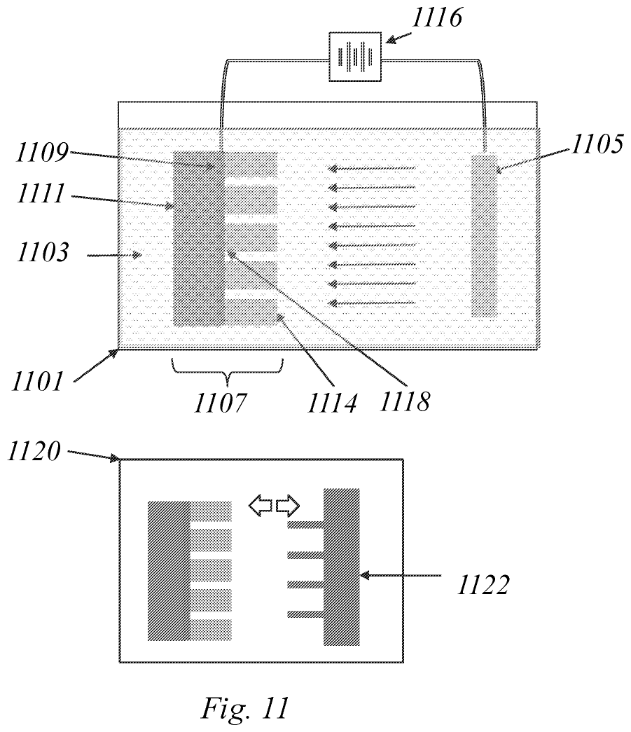

An original patterned silicon wafer or the like with posts could be used as tools to mold NP membranes; however, these tools need to be produced in semiconductor facilities, typically by e-beam serial writing or expensive short wavelength mask exposure, to form the post pattern and are therefore very expensive. They are also prone to post breakage and tool clogging, as posts made of silicon-especially those having a high aspect ratio-tend to be brittle and susceptible to breakage by small lateral forces. A feature of the present disclosure uses breakage-resistant post tools that can tolerate reasonable bending and/or shear forces. These tools can be malleable metals, such as formed by the known technique of electroplating, shown in FIG. 11.

FIG. 11 shows plating tank 1101 filled with plating solution 1103 appropriate for the metal to be deposited (such as nickel sulfamate for Ni electroforming, etc.) with metal anode 1105. The cathode (plating workpiece) 1107 consists of an electrically conductive layer 1109 on support film 1111. Alternatively, substrate 1111 can be a conductive foil that eliminates the need for layer 11o9. The conductive surface is covered with a non-conductive mold layer 1114 have a hole pattern corresponding to the mirror image of the post pattern described above, where the bottom of the hole 1n8 is open to the underlying conductive layer. DC power supply 1n6 causes current to flow in the plating cell, as is well known in the art of electroplating, to transfer metal atoms from the anode to the cathode. Plating growth begins only at the exposed areas 1118 and continues in the direction toward anode 1105. Growth is constrained by the non-conductive walls of the hole mold, and once the hole cavities are filled, the deposited metal begins to grow laterally across the top of the mask until the metal forms a continuous layer that will become the support for the post tool, as illustrated in inset 1120.

Upon reaching the desired support layer thickness, the deposition process is stopped and the metal post array 1122 is separated from the cavity tool. The conductive surface 1109 is chosen to have weak adhesion to the deposited metal for easy separation, for example using an indium tin oxide (ITO) conductive layer with Ni plating. In addition to electroformed Ni, other metals, including but not limited to Cu, Ag, Au or other can be plated. For roll-based manufacturing, the mandrel can be placed inside a cylindrical plating fixture [ref U.S. Pat. Nos. 7,674,103 B2, 7,833,389 B1, 8,062,495 B2 and related] to form a rotary post tool or can be used in the form of a belt to produce a continuous roll of metal post tools.

Hole mandrel 1114 can be made by various well-known lithographic techniques, with the preferred method being nanoimprint lithography and described in the Applicant's co-owned U.S. Pat. No. 8,435,373, the entire content of which is incorporated herein by reference.

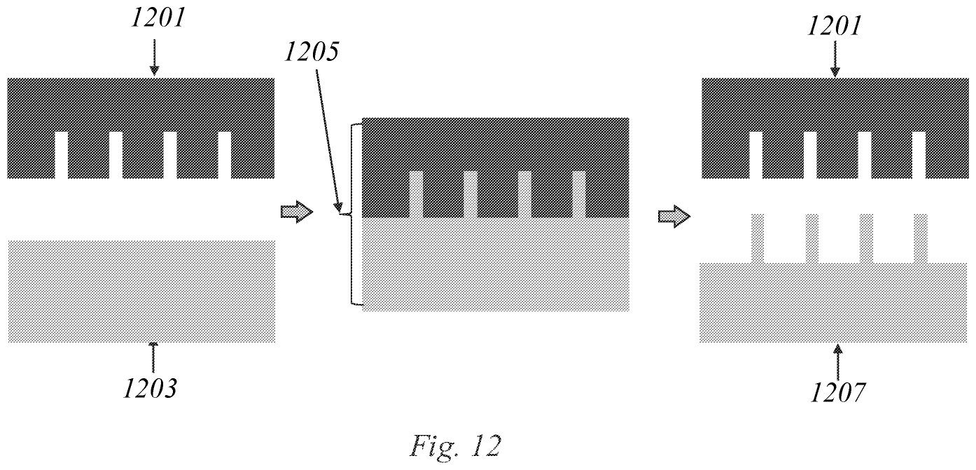

In addition to using metal post tools, the use of polymeric post tools to form a porous filter or membrane is a preferred embodiment of the present disclosure due to their flexibility and higher resistance to post breakage relative to Si or other brittle materials. FIG. 12 is a schematic of a nanoimprint method for making flexible post tool films (mandrels), in accordance with the present disclosure.

As shown in FIG. 12, polymer mandrels 1201 are formed by nanoimprinting into the surface of polymer film 1203. This can be carried out by any of several methods known to the art, including chemical softening, thermal or UV nanoimprinting. A preferred mandrel post tool is made from Zeonor (cyclic olefin) film, such as made by Zeonex Corp (Tokyo, Japan), which is preferred due to its high-quality replication capability for high aspect ratio posts and good chemical resistance to many UV-curable materials. Other materials (polycarbonate, cellulose acetate butyrate, etc.) can also be used for a polymer post tool. Mandrel 1201 may be made by silicon etching, metal plating or other suitable process selected for ease of nanoimprinting the post pattern. The tool and substrate are brought into direct contact at 1205, and after solidification are separated into reusable tool 1201 and post mandrel 1207. This form of direct patterning is preferred over UV molding to make such tools due to adhesion failure at the resist/substrate interface, which could leave delaminated polymer posts clogging post-forming tool 1201.

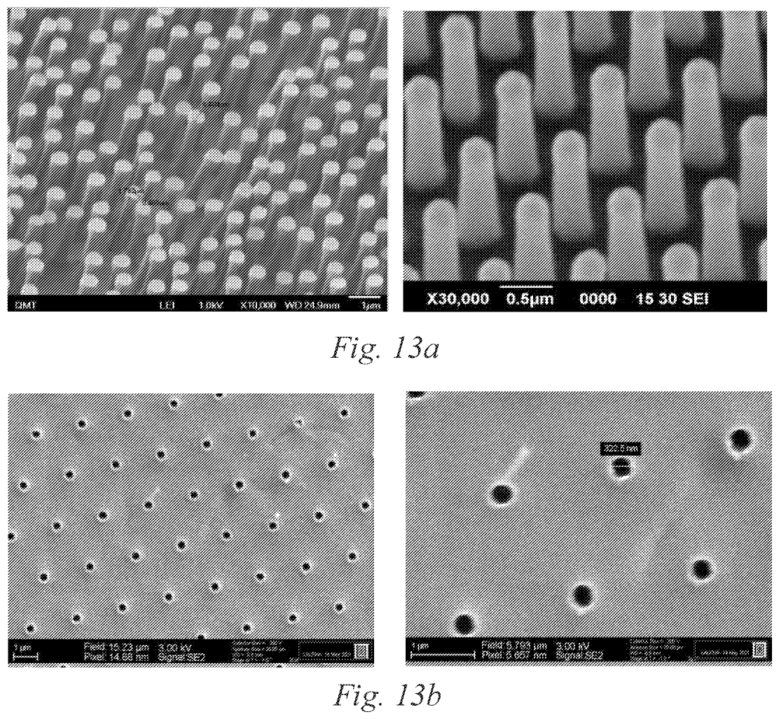

FIGS. 13a-b are SEM images of a polymer post tool and polymer pores, in accordance with an exemplary embodiment of the present disclosure. FIG. 13a (left) is an image of a quasi-random post mandrel made using Zeonor film, and (right) an image of a periodic post mandrel. FIG. 13b is an image of a submicron hole array in a polymer film at low magnification (left) and high (right) made from a periodic Si post tool.

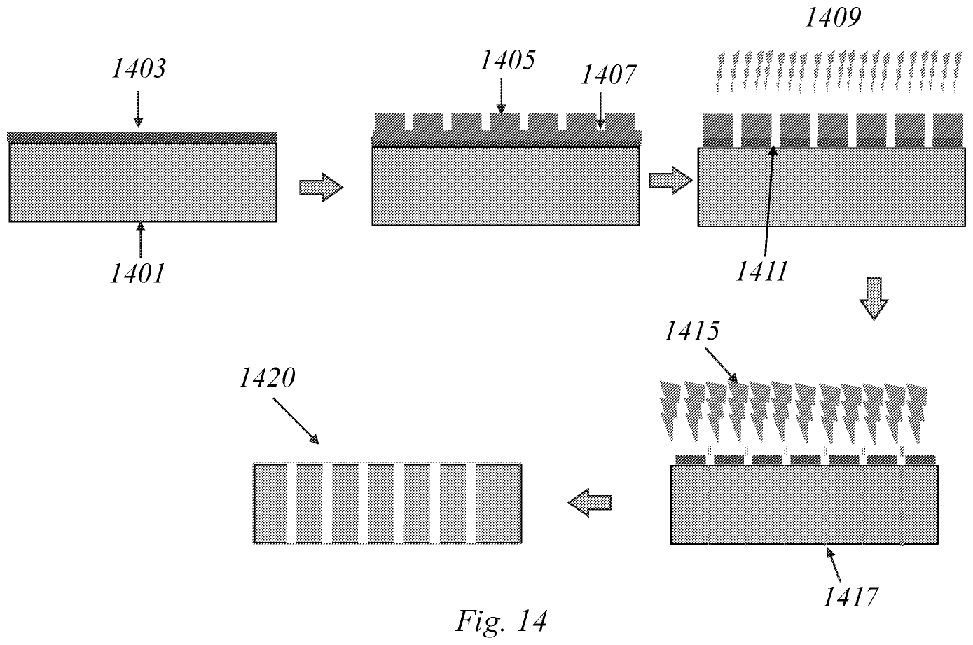

FIG. 14 illustrates another method for forming pores with uniform diameter and pre-determined spacing that addresses the shortcomings of TE membranes, as has been described above. In this embodiment, a metal mask with openings corresponding to a desired pore shape and spacing is formed by nanoimprinting. The thin metal mask is used to stop heavy ions in the area of the substrate covered by metal, while allowing bombardment through the openings of the mask by a high flux of ions.

The ability of thin metal layers to stop heavy ions to good approximation follows the known Bethe-Bloch Equation. Using a suitable (known) range-energy calculator, for example, as described at http://handcrafted.codes/Dreamweaver/Dreamweaver.htm, the stopping power of copper, for example, for 10 MeV ion beams of hydrogen, aluminum, and lead can be determined to be as follows:

TABLE 1

| Element | Z | Stopping Power of Cu | |
|---|---|---|---|
| Hydrogen | 1 | 24.0 | keV/μm |
| Aluminum | 13 | 3.774 | MeV/μm |
| Lead | 82 | 8.549 | MeV/μm |

In this example, a layer of Cu less than 1.5 μm thick will efficiently stop a 10 MeV lead heavy ion beam.

To produce the ion beam attenuating layer, substrate 1401 is coated with hardmask layer 1403 made from a metal such as, but not limited to, Cu, Ag, Au, Pt, Pd, Al or other. Polymer mask 1405, composed of an array of holes with a desired diameter and distribution, can be formed by nanoimprinting, as described above, or as described in the Applicant's co-owned U.S. Pat. No. 8,435,373, the entire content of which is incorporated herein by reference. Residual polymer at the bottoms of the imprinted polymer wells 1407 is removed by plasma or other etching (sometime referred to as “de-scumming”) 1409, thereby exposing the underlying hardmask metal 1403 through the openings in of the polymer mask. The exposed metal layer is then removed by plasma or wet etching, thereby exposing bare substrate 1401 at the bottoms of the polymer mask holes. The remains of polymer mask are then removed by plasma etching or other liftoff technique. A semi-transparent mask may also be used to pattern the hardmask 1411, such as described in the Applicant's co-owned U.S. Pat. Nos. 8,845,912 and 10,737,433, the entire content of each of which is incorporated herein by reference. After mask liftoff, the substrate with perforated metal hardmask 1411 mask is exposed to strong ionizing radiation 1415 using known techniques of track etching, referenced above. In this case, the perforated metal serves to attenuate the incident radiation, allowing exposure only through the openings in the metal mask. Since the radiation impingement is random, the process is allowed to continue until all of the holes have been irradiated, by which process the ionizing radiation creates latent image tracks 1417 only in the metal-free areas. Techniques known to the art of track etching are then used to develop the tracks, removing polymer material to create porous self-supporting film 1420. Perforated hardmask 1411 may be removed as part of the track etch process or may be left in place where desired, such as when the biocidal activity of certain mask metals (Cu, Ag) is a desired component of the filtration process.

### Roll-to-Roll and Roll-to-Plate Manufacturing:

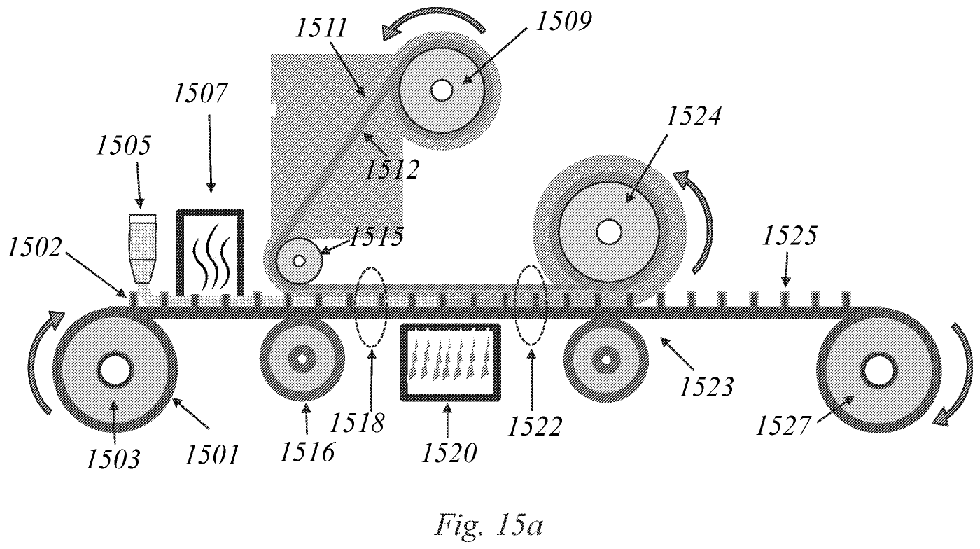

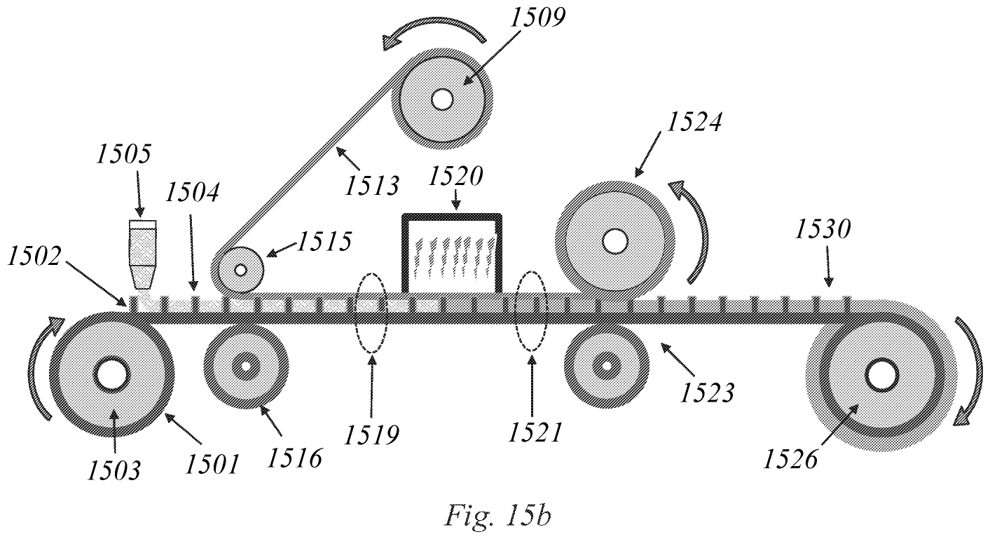

In order to provide large-area and cost-effective precision filtration materials according to the present disclosure, exemplary methods of filter production based on roll-to-roll (R2R) and roll-to-plate (R2P) processes are now described with reference to FIGS. 15a-15b. The following examples should not be considered limiting in terms of the R2R and R2P configurations that can be used to carry out the various embodiments of the present disclosure.

In a R2R method shown schematically in FIG. 15a, a roll of polymer film 1501 having a post pattern 1502 formed by methods described above and functioning as a post mandrel film 1525, is continuously unwound from supply spool 1503 and fed into a first zone where membrane-forming resist 1505 is applied to the substrate by any of various suitable techniques, including slot die coating, or ink jet techniques as described in the Applicant's U.S. Pat. No. 10,759,095, entitled “Fluid Application Method for Improved Roll-to-Roll Pattern Formation,” the entire content of which is incorporated herein by reference, and slot die coating. The resist can be neat or diluted, where for the latter case drying zone 1507 is located after the resin application zone to control the amount of residual solvent, when used. Another unwinds spool 1509 feeds pre-filter film 1511 on carrier film 1512 into lamination zone consisting of lamination roll 1515 and backing roll 1516. The laminate 1518 then travels into radiation curing zone 1520. Cured resist 1522 is then separated from the post mandrel film at delamination zone 1523, where it is rewound onto take-up spool 1524. Mandrel film 1525 is rewound on take-up spool 1527 for optional reuse. Post pattern 1502 may alternately be formed by techniques described in Applicant's co-owned U.S. Pat. No. 10,546,607, entitled “Replication Tools and Related Fabrication Methods and Apparatus,” U.S. Pat. No. 10,546,722, entitled “Roll-to-Roll Patterning of Transparent and Metallic Layers,” and/or U.S. Pat. No. 7,833,389, entitled “Replication Tools and Related Fabrication Methods and Apparatus,” the entire content of each of which is incorporated herein by reference.

FIG. 15b is a diagram showing an embodiment of the R2R process for producing self-supporting membranes, in accordance with the present disclosure. As in the previous example (FIG. 15a), resist-coated post mandrel film 1504 is laminated to temporary cover sheet 1513, supplied from roll 1509, by pressure lamination rolls 1515 and 1516 (an optional solvent control zone prior to lamination is not shown). Laminate 1519 is next transported into radiation curing zone 1520, producing cured laminate structure 1521. Temporary cover sheet 1513 is then delaminated in zone 1523 and rewound onto take-up spool 1524. Membrane 1530 on post tool roll 1502 is rewound onto spool 1526. Membrane 1530 can later be separated from tool 1502 (not shown) or can be continuously separated at a subsequent delamination station before rewind (not shown).

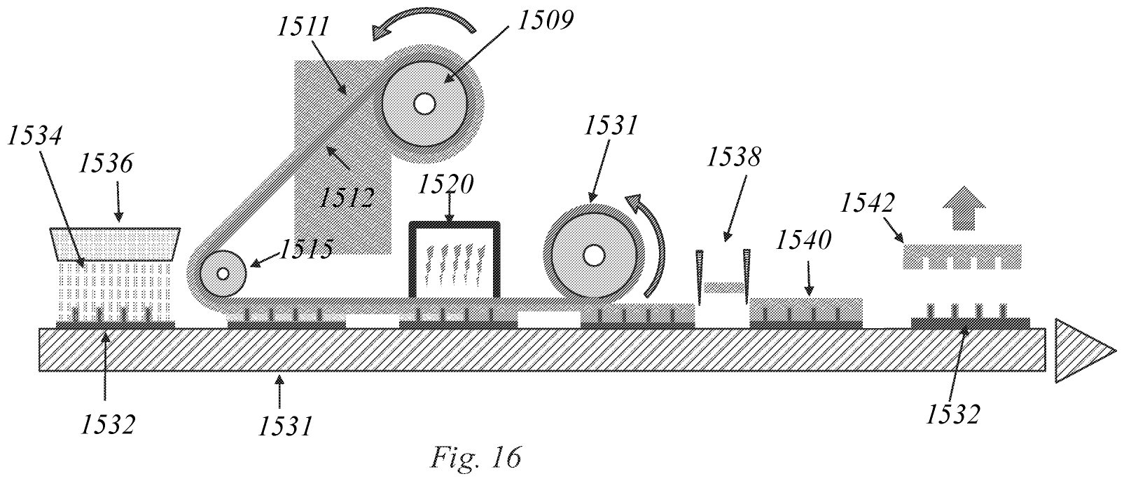

FIG. 16 depicts a roll-to-plate (R2P) variant 1600 of the R2R process of FIG. 15a. Here, conveyor belt 1531 is used to transport discrete coupon sections of post mandrel tool 1532 into a deposition zone where resist polymer 1534 is dispensed, in this embodiment from ink jet applicator 1536. The coated panel is then brought into contact with pre-filter 1511 on temporary carrier 1512 supplied from unwind spool 1509. The coated coupon and continuous pre-filter/support film are laminated at roller 1515. The laminated panel is then transported to curing station 1520, where the resist is solidified. Carrier film 1512 is delaminated from the panel and rewound onto take-up spool 1531, while the laminate continues into slitting station 1538 where excess pre-filter material is removed. Discrete coupon 1540 is then delaminated from tool 1532 by peeling or other automated means (not shown), and finished filter element 1542 is stacked for packaging (not shown). Post template 1532 may be reused.

These R2R and R2P processes (described for FIGS. 15-16 and/or in Applicant's referenced incorporated patents) can be used to produce large-area and cost-effective precision filtration materials according to the present disclosure. For example, webs in the range of 4-in to 36-in in width are achievable, and lengths of the webs can be over 1,000 ft. Exemplary preferred web widths of between 6 in, and 12-in. can easily be achieved, and at web lengths greater than 1,000 ft. For R2P processes, exemplary plate size can range between 4 in.×4 in. to 36 in.×36 in. (3 ft×3 ft); the plates are of course not restricted to a square shape. Preferred sizes for the plates range from 6 in.×6 in. to 12 in.×12 in.

### FURTHER EXEMPLARY EMBODIMENTS

The following clauses refer to and describe exemplary embodiments of the present disclosure:

Clause 1: a method for forming a filter membrane for liquids or gases or both having pores of pre-determined size, spacing and thickness by casting a curable polymer liquid onto a post tool, followed by curing and separation.

Clause 1.1: The polymer can be solidified by UV curing.

Clause 1.2: The polymer can be solidified by solvent removal.

Clause 1.3: The polymer can be applied by any of ink jet printing, slot die coating, lamination, or other application technique.

Clause 1.4: A laminated temporary cover sheet can be used to exclude air and improve thickness uniformity.

Clause 1.5: A temporary cover sheet with an elastomeric layer can be used to improve liquid contact and oxygen exclusion.

Clause 1.6: The pores can have micron and/or nanometer size openings.

Clause 1.7: The pores can have non-circular-shaped openings (apertures) and/or cross sections; the cross sections can vary along the length of the pore.

Clause 1.8: A filter can be formed with high pore packing density and uniformity.

Clause 19: A filter stack can be created with additional functionalities in addition to filtration.

Clause 1.9.1: The filter stack can have hydrophobic properties.

Clause 1.9.2: The filter stack can have biocidal materials having biocidal properties including pathogen-nucleic-acid denaturation and/or inactivation.

Clause 1.10: Plasma etching can be used to remove polymer material extending above the tops of the mandrel posts.

Clause 1.11: Chemical etching can be used to remove polymer material extending above the tops of the mandrel posts.

Clause 2: A method for forming a membrane with pores of pre-determined size and spacing by casting a curable polymer liquid onto a post tool, followed by lamination of a pre-filter layer, followed by curing and separation.

Clause 2.1: The polymer liquid can be solidified by UV curing.

Clause 2.2: The polymer liquid can be solidified by solvent removal.

Clause 2.3: The polymer can be applied by any of ink jet printing, slot die coating, lamination, or other suitable technique, e.g., 3D printing.

Clause 2.4: The pores can have (be formed with) micron and/or nanometer sizes.

Clause 2.5: The method can result in forming a filter with high packing density and pre uniformity.

Clause 2.6: The method can include creating a filter stack with additional functionalities in addition to filtration.

Clause 2.6.1: For example, an additional property can include a hydrophobic property.

Clause 2.6.2: For example, an additional property can include a biocidal pathogen nucleic acid denaturation and inactivation property.

Clause 2.7: The method can include increasing adhesion of a filter membrane to a pre-filter, without clogging, by using a solvent-containing polymer to interpenetrate prefilter before solidification.

Clause 2.8: The method can include using a temporary filling of pre-filter with liquid before lamination to polymer coated post tool to prevent ingress of polymer into pre-filter, followed by liquid removal and separation.

Clause 2.8.1: The temporary pre-filter filling material can be water.

Clause 2.8.2: The temporary pre-filter filling material can be solvent or mixture of solvents to control mixing with membrane polymer.

Clause 2.9: the pre-filter can be adhered to porous polymer membrane by heat.

Clause 2.10: The pre-filter can be adhered to porous polymer membrane by chemical softening.

Clause 3: A method for producing a breakage resistant post tool for casting and separating porous membrane.

Clause 3.1: Post tool is flexible polymer.

Clause 3.1: Post tool is cyclic olefin copolymer, cyclic olefin polymer, polycarbonate, PMMA, cellulose acetate.

Clause 3.1: Post tool is formed by metal plating into hole mold followed by separation from mold.

Clause 3.1: Tool in 3.2 is formed by electroplating.

Clause 3.1: Tool is formed by Ni electroforming, or copper, silver or plating of other metal.

Clause 3.1: Hole mold for plating has electrically conductive bottom layer and non-conductive sidewalls and top surface.

Clause 3.1: Hole mold is formed by imprinting polymer hole pattern onto conductive bottom substrate.

Clause 3.1: Bottom layer is metalized film.

Clause 3.1: Bottom layer is indium tin oxide.

Clause 3.1: Tool is formed by electroless plating.

Clause 3.1: Method for forming porous membranes with predetermined vertical and cross-sectional profiles.

Clause 3.1: Membrane is cast from tapered tool posts.

Clause 3.1: Membrane is cast from tool having one or more steps of decreasing diameter from base to top.

Clause 3.1: Steps are cylindrical or tapered.

Clause 3.1: Posts have pointed tips for improved pre-filter penetration.

Clause 3.1: Tools formed by Claim 4 have groupings of posts surrounded by walls to minimize post breakage and provide uniform membrane thickness

Clause 3.1: Post have release coating for improved separation of membrane.

Clause 3.1: Coatings is one of sputtered PTFE, 3M Novec or other low-energy release material.

Clause 4: Method for forming filters with pores of pre-determined size, spacing and thickness by roll-to-roll process in which a roll of pre-patterned post tools is unwound, coated with liquid polymer membrane material, controllably solidified, then laminated to a pre-filter roll, and rewound.

Clause 4.1: Polymer membrane material is solidified by UV curing.

Clause 4.2: Polymer membrane material is solidified by removal of one or more solvents.

Clause 4.3: Polymer material is partially cured before dry lamination of pre-filter.

Clause 4.4: Polymer material is bonded to pre-filter by thermal lamination.

Clause 4.5: Membrane-forming polymer liquid is applied to post tool by ink-jet printing.

Clause 4.6: Membrane-forming polymer liquid is applied to post tool by slot die coating.

Clause 4.7: Membrane-forming polymer liquid is applied to the post tool by roll lamination.

Clause 4.8: Self-supporting membrane is formed by eliminating pre-filter and laminating against temporary cover film.

Clause 4.8.1: Cover film has elastomeric coating on tool contact surface.

Clause 4.9: The method of clause 4 in which carrier for pre-filter is delaminated prior to windup of porous of laminated pore-filter and membrane.

Clause 5: A method for forming filters with pores of pre-determined size, spacing and thickness by roll-to-plate process in which a pre-patterned post tool panel is carried into a polymer deposition zone, coated with liquid polymer membrane material, controllably solidified, laminated to pre-filter roll, the panels separated by cutting, followed by stacking

Clause 5.1: Polymer membrane material is solidified by UV curing.

Clause 5.2: Polymer membrane material is solidified by removal of one or more solvents.

Clause 5.3: Polymer material is partially cured before dry lamination of pre-filter.

Clause 5.4: Polymer material is bonded to pre-filter by thermal lamination.

Clause 5.5: Membrane-forming polymer liquid is applied to post tool by ink-jet printing

Clause 5.6: Membrane-forming polymer liquid is applied to post tool by slot die coating

Clause 5.7: Membrane-forming polymer liquid is applied to post tool by roll lamination

Clause 5.8: Self-supporting membrane is formed by eliminating pre-filter and laminating against temporary cover film

Clause 5.9: Cover film has elastomeric coating on tool contact surface

Clause 6: A method for forming filters with pores of pre-determined size and spacing by forming a metallic layer on a substrate of a desired thickness, using nanopatterning to form a polymer resist mask having the desired pores over the metallic layer, and plasma or wet etching through the open pores of the mask to expose the underlying substrate, followed metal stripping, followed by the known methods of track-etching to form tracks only in the non-exposed areas.

Clause 6.1: Metal in clause 6 is chosen to resist bombardment by high energy heavy ion beams

Clause 6.2: Substrate in clause 6 can be any of polycarbonate, polyimide, polyester, or other suitable film.

Clause 6.3: Metal of clause 6 can be further selected for its biocidal activity.

Clause 6.3.1: Metal may be copper or silver.

Clause 7: A porous filter composed of: a first layer having of a set of pre-determined spaced through holes; and, the holes being non-overlapping and providing an absolute size cutoff.

Clause 7.1: The porous filter of clause 7 further including: a second layer bonded to the first layer and having substantially larger through holes to provide mechanical support and selective removal of larger particles; one or more optional layers can be applied to or bonded on one or both outer surfaces of the bonded structure to provide additional functionality to the filter.

Clause 7.2: The porous filter of clause 7 wherein the through holes have a diameter or maximum opening between 0.05 to 10,000 nm.

Clause 7.3: The porous filter of clause 7 wherein the spacing of the through holes is between 1 and 100 times the through hole diameter or maximum opening between.

Clause 7.4: The porous filter of clause 7 wherein the spatial distribution of pores is uniform according to a lattice chosen from: hexagonal, square, rectangular, oblique, or centered rectangular; the corresponding distribution of a post tool or mandrel used to make the pores can have a corresponding like spatial distribution, as described above.

Clause 7.4: The porous filter of clause 7 wherein the spatial distribution of pores is either nonuniform or random.

Clause 7.5: A post tool for casting the pores of clause 7 comprising a flexible polymer chosen from cyclic olefin copolymer, cyclic olefin polymer, polycarbonate, PMMA, and cellulose acetate.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity (e.g., item or component) or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by an “a” or an “an” does not, without further constraints, preclude the existence of additional elements of the identical type.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

What is claimed is:

1. A method of forming a filter membrane for filtering fluids, the membrane having pores of pre-determined size and spacing, the method comprising:
applying a polymer liquid onto a post tool, wherein the polymer liquid is curable, and wherein the post tool includes a plurality of posts having a predetermined shape with a maximum width and a height;
curing the polymer liquid, resulting in a cured polymer; and
causing separation of the cured polymer from the post tool, wherein the cured polymer separated from the post tool forms a filter membrane having pores of pre-determined size, spacing, and thickness.

2. The method of claim 1, wherein the polymer is solidified by UV curing.

3. The method of claim 1, wherein the polymer is solidified by solvent removal.

4. The method of claim 1, wherein the polymer is applied by ink jet printing.

5. The method of claim 1, wherein the polymer is applied by lamination.

6. The method of claim 1, further comprising using a laminated temporary cover sheet to exclude air and improve thickness uniformity.

7. The method of claim 1, further comprising using temporary cover sheet with elastomeric layer to improve liquid contact and oxygen exclusion.

8. The method of claim 7, wherein the filter stack includes hydrophobic properties.

9. The method of claim 7, wherein the filter stack includes biocidal pathogen nucleic acid denaturation and inactivation.

10. The method of claim 1, further comprising using plasma etching to remove polymer material extending above the tops of the tool posts.

11. The method of claim 1, further comprising using chemical etching to remove polymer material extending above the tops of the tool posts.
